(19) United States
(12) Patent Application Publication
(10) Pub. No.: US 2012/0153179 A1
(43) Pub. Date: Jun. 21, 2012

(54) PRODUCT EFFECTIVENESS MONITORING DEVICE

(76) Inventor: Steve Tew, Oxfordshire (GB)

(21) Appl. No.: 13/375,283

(22) PCT Filed: May 28, 2010
(86) PCT No.: PCT/GB2010/050891

§ 371 Date: Feb. 27, 2012

(30) Foreign Application Priority Data
Jun. 1, 2009 (GB) 0909298.2
Jul. 20, 2009 (GB) 0912483.5

(51) Int. Cl. G01J 1/42

(52) U.S. Cl. 250/372

(57) ABSTRACT

A monitoring device (201, 102, 104) which is attached to or integrated within a product container body, lid, cap or spray unit (200) with a built in sensing indictor alarm circuit that indicates and gives a audio indication that the effectiveness of a product has been reduced below a predetermined level. The product could be a sun protection material in the form of a liquid, cream or lotion or other materials in the forms of medicines, food, toiletries etc. The device may alert the user when exposed to ultraviolet radiation for a specified period, that they need to re-apply the sunscreen material, thus reducing the risks associated with over exposure to UV radiation. The monitoring device may also indicate to the user that the product is at or has gone beyond its expiration date and helps prevent use of the product before it becomes hazardous.

The present invention relates to a monitoring device to monitor the effectiveness of a product and alert a user when the effectiveness is reduced below a predetermined level.

Sunscreens in the form of creams and lotions, for example, are applied all over the body to protect from harmful UV A & B radiation, but most people have no idea when they should re-apply sun protection. Typically a lotion bottle will state “re-apply frequently” but “frequently” is ambiguous, do you re-apply every hour, two hours or until a user feels burning?

There are three types of skin cancer: the two most common are Basal Cell and Squamous Cell Carcinomas. They are easily treated and rarely fatal. The third and most dangerous is the malignant melanoma.

Skin cancer is the second most common cancer in the United Kingdom, with about 40,500 new cases each year, of which 6,000 are malignant melanomas. About 1,500 people die from melanomas in Britain every year.

By the year 2001, more than 1% of the people in the US will get malignant melanoma. The UK figure is 1 in every 150-200.

There is strong evidence that melanomas occur on sun-damaged skin and that people are particularly at risk when they have sudden, short bursts of sunlight on holidays in places where the sun is very strong.

A tan is not a sign of health; it is a sign that the skin has been damaged by ultraviolet radiation. When cells are damaged by the sun, melanin rushes to the surface to provide protection against the next onslaught. As you slowly build up a ‘protective’ tan, your skin is darkening in response to damage on top of damage. Over the past 60 years, damage to the planet's ozone layer has increased the amount of harmful radiation that reaches your skin.

UV radiation is made up of UVA and UVB rays. UVA ages the skin and UVB burns the skin. Both can cause skin cancer, UVA is suspected to be involved in photo-aging of skin that said, 90%-95% of our vitamin D requirement comes from exposure from sunlight, so it's essential to receive sunlight.

Sunscreens can lose their effectiveness for many reasons. They can wear off by sweating, abrasion, swimming, absorption into the skin, migration on the skin, and photo-degradation, and these removal mechanisms are important in sun protection by sunscreens. Mechanisms by which a sunscreen wears off create a problem in that a consumer cannot tell when the sunscreen has stopped providing effective UV protection.

The effectiveness reduction of the sunscreen material described above is not the only concern. A variety of products have a limited lifetime and are therefore marked with an expiration date beyond which they should not be used. Medicines in the form of, for example, liquids, creams and lotions, ointments, gels, liniments, balms, salve, tablets can be applied to the body, or they can be taken orally, or injected, in order to protect from or treat various conditions. However, many drugs lose their potency with age, such that, over time medications may lose their effectiveness, potentially placing the user at risk. This is a particularly important issue when a patient is using a maintenance drug such as an inhaler or a cholesterol-lowing prescription. As a result, the manufacturer of a medicine cannot guarantee the strength and potency of their product past the printed expiration date.

TW 290773B relates to a UV detector. This includes a solar cell module, a UV sensor and a sensor driving unit. The UV sensor is electrically connected to the solar cell module and is suitable for detecting the UV light as well as generating a sensing signal. The sensor driving unit is electrically connected to the solar cell module and the UV sensor, and is suitable for generating a driving signal to drive the UV sensor and receiving the sensing signal generated from the UV sensor.

U.S. Pat. No. 4,704,535 discloses an ultraviolet radiation dosimeter to be employed by a person the skin of whom has been protected by a substance tending to inhibit the transmission of the radiation therethrough and which substance has a predetermined value of inhibition. Disposed to the radiation is a sensor that develops a signal in correspondence to the level of the radiation. Responding to that signal is a processor which accumulates a representation of the magnitude of the signal as effectively integrated with an elapsed time of exposure of the sensor to the radiation. An indication of the degree of the accumulation is yielded in response to the representation of the magnitude. The value of inhibition is used in order selectively to adjust in correspondence thereto the determination of the degree at which the indication is yielded. Both analogue and digital circuitry are presented, along with variations and additions such as also adjusting response in accordance with the skin type of the user.

Such electronic UV detectors have to be carried separately by the user, and have buttons that require the user to program in their data. This is both confusing, inconvenient, and can be messy if the user has sun lotion on hands when entering data.

Expired medicines can also become dangerous. For example, outdated eye and/or eardrops may no longer be sterile once they have been in use for sometime, possibly causing infection and/or irritation. Tetracyclines are “broad-spectrum” antibiotics used to treat a wide variety of infections. Doctors may prescribe these drugs to treat eye infections, pneumonia, gonorrhea, and other bacterial infections, and they can also be used to treat acne. Expired Tetracyclines have the potential to cause serious damage to the kidneys.

The expiration of a medicine can also be accelerated if the product has been exposed to air, moisture, agitation, UV radiation and/or different temperatures throughout its life cycle. Exposures of this type can cause the active ingredient in the product to react, rendering a change in the drug's potency. For example, when aspirin is stored in a bathroom medicine cabinet, prolonged exposure to moisture in the air can cause the active ingredient in aspirin to convert to acetic acid, causing a reduction in potency. As a further example, insulin should normally be kept at low temperature. However, when travelling overseas, insulin can typically be exposed to temperatures exceeding the ideal for days or even weeks. Exposing insulin to high temperatures makes the insulin weaker, reducing its efficiency, such that the dosage that the user would normally take may no longer be appropriate. Furthermore, some medications in a liquid form can actually increase in strength over time, for example, due to evaporation of non-active components, leaving more of the active ingredient.

For these reasons it is important that a medicinal product is not used beyond its expiration.

There are other risks in using ‘old’ and/or expired medicines; for example, before writing a prescription a doctor is likely to have asked what other drugs an individual was currently taking and, based on the response, the doctor may have chosen a specific drug in order to avoid a hazardous drug interaction that may otherwise occur. If an individual was then to take the prescribed medication quite sometime later, not only may it have expired, but it may also be that the individual is now using some other drug that could cause a dangerous and possibly deadly interaction with the prescribed medication.

WO03096309 relates to a method of judging the storage condition of food and beverages etc, during distribution, and an indicator thereof. This method is based on a technique comprising enclosing and sealing a dye component containing a pH colour changeable dye having its pH value adjusted, together with a micro-organism derived from the food or beverage in a sealed transparent container of synthetic resin or transparent small bag of soft film, and judging the quality of low-temperature preservation of the food or beverage on the basis of the degree of colour change attributed to the action of the dye component.

JP9101382 relates to a time indicator for indicating the term of validity of a medicine or the like and describes an electronic circuit within an external case fixed onto a container or impregnated within the body of the container, indicating the elapsed time on a liquid crystal screen.

WO2007117273 discloses a device for monitoring one or more of the integral value of time and temperature, UV light exposure and a pre-determined temperature of an item such as Self-indicating Instant Radiation Alert Dosimeters (SIRAD). The device makes use of the polymerization of diacetylenes and the melting of partially polymerized diacetylenes, both of which are associated with color changes, as an indicator of a false positive, a false negative, or tampering.

These product expiration indicators use various methods to indicate products validity, some using chemical reactions, which can be unreliable, or, in the case of JP9101382, using an electronic circuit that does not take into account the environmental conditions to which the product may be exposed.

In accordance with one aspect of the present invention there is provided a product monitoring device indicating that the effectiveness of a product has been reduced below a predetermined level. The device is attached to or integrated within a packaging for the product.

Thus the monitoring device indicates that the effectiveness of the product has reached a level at which the user should replace or discard the product. This indication may be that the product is at or has gone beyond its expiration date, and/or that more of the product should be applied or used.

The product monitoring device may be a UV radiation monitoring device. Such a device may indicate that the product's effectiveness has reduced below a predetermined level due to exposure to UV radiation. In this case, the product may be a sun protection material in the form of a liquid, cream or lotion.

Thus, in accordance with one embodiment the present invention there is provided a sun screen protection material monitoring device that provides an indication that a user has received a predetermined dose of UV radiation. The device forms part of a packaging for a sun protection material.

The device provides an indication that the effectiveness of the sun screen material has been reduced to a level that erythema may occur. This then gives the user a chance to apply more lotion before damage is done by the sun, dramatically lowering the risk of skin cancer. This indication may be controlled by an electronic monitoring circuit, which may be hidden inside the packaging, and an ultraviolet light receiver that is attached to the circuit.

The device may be attached to or integrated within in a body, lid, cap or spray unit of a container for the product. The container may be in the form of a dispenser. The device may be activated when a portion of the dispenser is pressed to dispense the sun protection material. Optionally, the device can be activated when the lid of the container is removed or is flipped open.

Optionally, the device is provided with pre-programmed data for the sun protection material comprising: Sun Protection Factor (SPF) rating and target skin type.

The electronic monitoring circuit could be programmed to match the SPF rating of the lotion or other material within the packaging. For example, if a sunbather applied SPF 5 protection, he/she should be able to stay in the sun for 5 times longer than if he/she had no protection, so the alarm would go of quicker than if the lotion was SPF 15 protection, assuming the sun UV index was the same in both situations.

The device could be programmed to match the predicted skin type of the person using the lotion. For example, if a sunbather applies SPF 5 protection but has bought lotion specifically for sensitive skin, the alarm could be made to trigger accordingly, say for a person with less sensitive skin. For this, a dial, marked with “Skin type” or similar wording, or a sign may be provided on the packaging, so that when turned to the appropriate setting, the electronic monitoring circuit takes this into account that the user has a certain skin type and adjusts the time so the alarm goes of sooner or later depending on the setting

The device may be pre-set to account for factors such as the SPF of the material within the packaging and/or the target skin type for the material. Whilst user applied settings are a possibility—particularly for example to make user specific changes—an absence of controls to operate makes matters easier for the user who does not have to adjust the monitoring device for the basic factors such as SPF and/or general skin type.

In general, it is advantageous to have a device that is pre-programmed for the SPF factor and/or the target skin type, whether or not the monitoring device is physically attached to or integrated with the container of the sun protection material or is otherwise associated with the material. For example, a package could include a container of sun screen material and also a separate monitoring device that is pre-programmed to match that material.

Thus viewed from another aspect of the invention there is provided a package comprising (a) a container for a product and (b) a monitoring device that provides an indication that the effectiveness of the product has been reduced below a predetermined level. The device can be optionally attached to or integrated within the container.

The monitoring device optionally provides an indication that a user has received a predetermined dose of UV radiation, wherein (a) the device stores a UV index that the device is exposed to; and (b) if the device detects that it has been removed from exposure to the sun, it uses the stored UV index to calculate the dose of UV radiation to which the user has been exposed, on the assumption that the UV index to which the user is exposed is the same as that stored.

The device could have a UV sensor that monitors the UV index, so that as long as the device picks up UV light, it knows how much radiation the user/bather is exposed to, for example,

If the lotion was applied at 9 am, the UV index on a sunny day at 9 am will be less than it would be at 11 am that day, so the alarm would trigger after 2 hours for example.

If the lotion was applied at 11 am on that same day, the UV index on a sunny day will be higher, so the alarm would trigger earlier at 1.3 hours for example.

The invention is also capable of dealing with the situation if the lotion from the monitored packaging is applied by the user, and the monitored packaging is subsequently placed in the shade whilst the user is still exposed to the sun, whether deliberately by the user placing it in a bag, pocket or the like to keep it out of the sun, or accidentally by dropping under a seat, towel or the like. Preferably, to account for that situation the electronic monitoring circuit takes a reading of the UV index, and stores the latest value. If the monitored packaging is placed in a dark environment, for example a bag, it will then switch to an automatic mode, in which it uses the most recent UV index it was exposed to, and predicts—for example through pre-programmed tables—when the user should apply more protection

Such an arrangement is of use whether the monitoring device forms part of the sun screen material container, is supplied in a package with a sun-screen container, or is an independent monitoring device—regardless of whether sun screen material is used.

The intention of the invention may be that the device is left in the sun at all times so it monitors the sun's UV index. This can be achieved without leaving a container of lotion in the sun, if the device is separate from or detachable from the container, such as being integrated within an outer the cap for the container.

The device is optionally provided with a user operated control to indicate that the user intends to enter water, and in response to operation of the control revises the calculation of when the user has received the predetermined dose, to take into account the degradation of the sun protection material.

If the user goes for a swim, the device can be instructed that this has happened, and optionally also when swimming is over. For example a section on the device, such as a lid, could be marked with “Press” or similar wording, or with a suitable sign. By pressing, squeezing or the like on this section, the electronic monitoring circuit is activated via a switch, takes into account the user is going swimming and adjusts the time so the alarm goes off sooner. The device could assume a certain amount of protection degradation from swimming, or if the section is pressed again on return it could calculate the time spent in the water and take that into account.

This again could be of use whether the device forms part of the sun screen material container, is supplied in a package with a sun-screen container, or is an independent monitoring device which takes into account that sun screen material is used.

Optionally, the device is arranged to provide a warning when the effectiveness of the sun protection material applied by the user has reduced below a predetermined level.

The device is optionally associated with a container of sun screen material and is arranged to provide a warning when the sun screen material in the container has reached the end of its useful life.

The warning is normally in the form of an audio signal, although other types of signal such as visible or haptic may be used.

In accordance with another aspect of the invention there is provided a product monitoring device that provides an indication that a product has expired, the device being attached to or integrated within a packaging for the product.

The device may indicate that a product has expired due to one or more of: exposure to UV radiation, exposure to temperature conditions, agitation and exposure to air and/or moisture, which may have affected the products expiration date.

The device is optionally provided with a clock function for measuring and maintaining the time. This clock function also monitors the user's swimming time span for which the device needs to be adjusted for the alarm to be triggered accordingly.

Optionally, the device is provided with one or more sensors for monitoring the condition and/or environment of the product and/or its packaging. The one or more sensors monitor one or more of: UV radiation, temperature, air, humidity, moisture, and agitation.

Optionally, the device can sense the aforementioned sensing functions, but may only have one or more of those sensing functions. The sensing function(s) employed in a particular implementation will be determined by the requirements of the product that is to be monitored.

Optionally, the sensors are activated by a manual switch or can be activated automatically.

The arrangement may be such that the sensors are activated manually by means of a mechanical or electronic switch, for example, at the time of using the product or, in another example, when the lid of the packing is flipped opened or removed, the device switches itself on and the sensor(s) are activated. The circuit may be programmed to switch on when one or more of the temperature, air, moisture, humidity, agitation or UV radiation exposure reaches a certain level. This may be independent of the user activating the monitoring circuit.

The circuit board footprint may be made very small using chip on board technology or surface mount technology.

Optionally, the device is provided with pre-programmed product data comprising one or more of: the date of manufacture, the latest possible expiration date, thermal tolerance, air tolerance, oxidation tolerance, moisture tolerance, agitation tolerance, and UV radiation tolerance.

The information or data relating to the aforementioned factors for a product could provide upper and lower limit conditions or tolerances at which the performance of the product may be affected.

Optionally, the device (a) stores sensor data gathered by the one or more sensors; (b) analyses the sensor data in conjunction with the pre-programmed product data; and (c) determines the time until expiry of product given the exposure of the product to various conditions.

When the monitoring circuit is activated, (for example, by the opening of the lid) the circuit then knows that the product is going to be exposed to certain conditions; its life expectancy will be challenged.

For example, if the lid for a medical ointment is opened, and left open for days, exposing the ointment to air and moisture, this will have an effect on the product. By analysing the data about the product, based on information gained from the manufacturers test results, and that has been pre-programmed into the device in conjunction with the data received from the sensors of the device regarding the environment to which the product has been exposed, the device can calculate and indicate when best to dispose of the medicinal product. This date may be sooner than the expiration date may otherwise had been, if the product had been exposed to different conditions.

In general, the product can be in forms such as, medicines in the form of, for example, ointments, gels, liniments, balms, salve and tablets, which can be applied to the body, or can be taken orally, or injected. The product can also be in the form of, for example, food and beverage, cosmetics and toiletries, cleaning products etc.

Optionally, the device is provided with an indicator for indicating that the product has expired. The indicator is optionally provided by one or more of: a visual indicator, an audio indicator, a haptic indicator, and a vibrating indicator.

Optionally, the device is provided with a display for displaying the time until the product is due to expire.

The device is optionally powered by a battery, wherein the battery is a rechargeable battery powered by a solar cell.

Some embodiments of various aspects of the invention will now be described by way of example only and with reference to the accompanying drawings, in which:

FIG. 1 shows an external side view of a spray head unit of a sunscreen lotion dispensing packaging, with the electronic monitoring circuit inside;

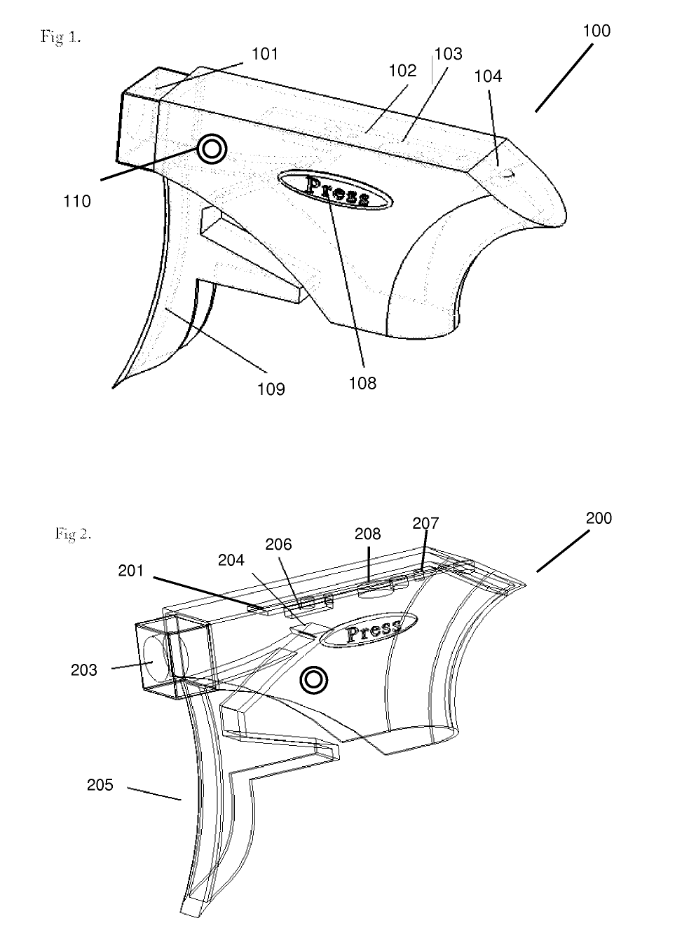

FIG. 2 shows the spray head unit of FIG. 1 where the electronic monitoring circuit and all the corresponding components inside the packaging are visible;

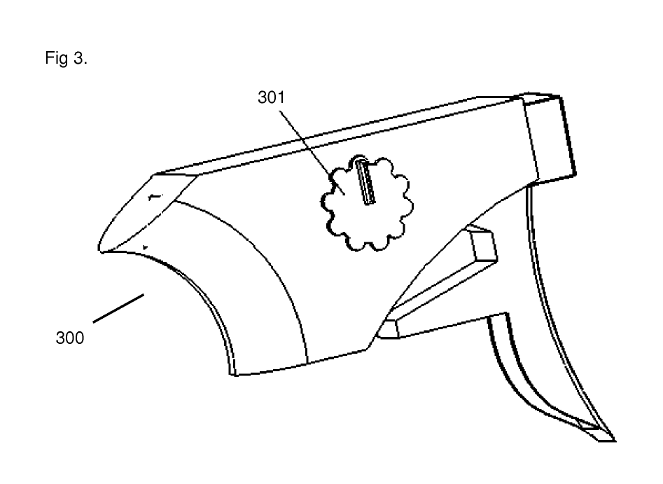

FIG. 3 shows the spray head unit as shown in FIGS. 1 and 2 with a skin type dial;

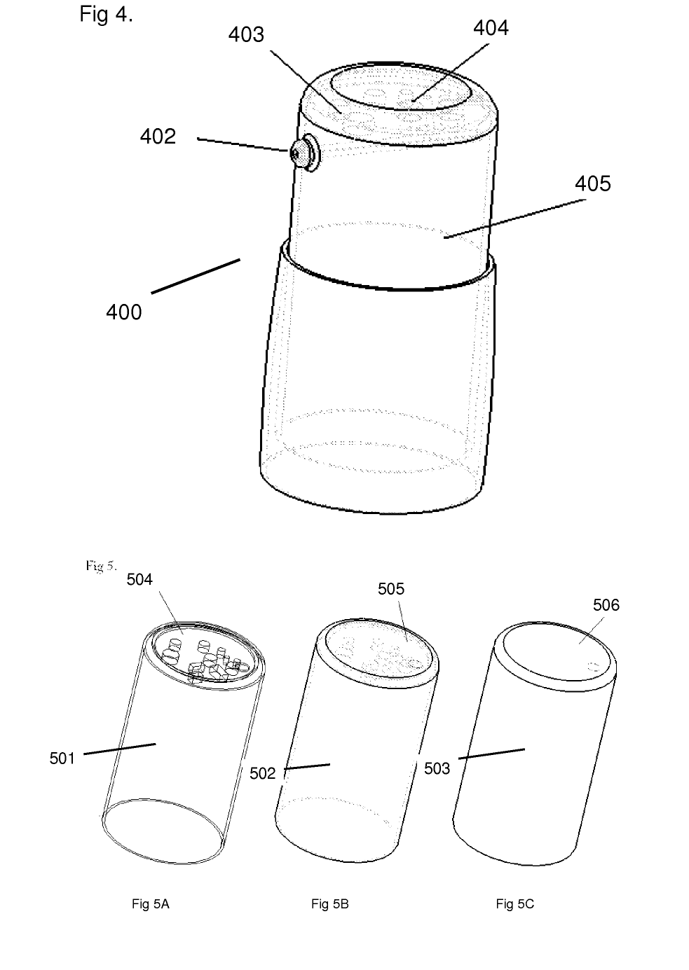

FIG. 4 shows the spray head unit in a different configuration shown in any preceding figure;

FIG. 5 shows a lid;

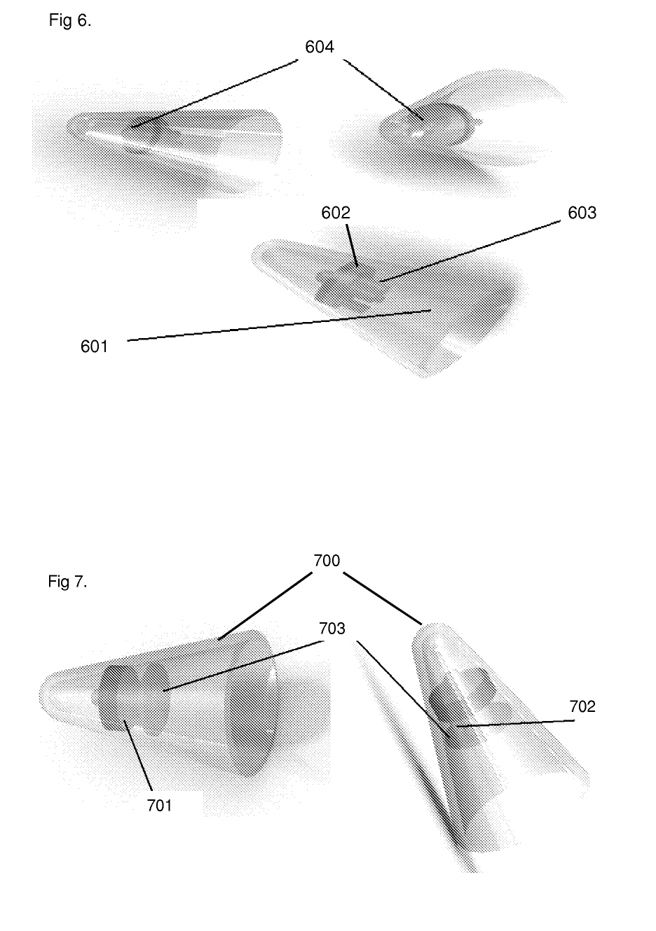

FIG. 6 shows a cap for an ointment tube with the monitoring device inside; and

FIG. 7, shows a tube cap.

FIG. 1 shows an external side view of a spray head unit 100 of a sunscreen lotion dispensing container. The spray head unit 100 comprises a nozzle 101 in which the lotion leaves the container. An electronic monitoring circuit 102 is provided, which is hidden inside the spray head unit 100. There is also provided a solar panel 103, a UV sensor 104 and a “Press” portion 108 which are placed on the unit 100. The spray head unit 100 comprises a trigger 109 that when pressed, activates the circuit 102, and pumps the lotion out. The monitoring circuit 102 controls the operation of the solar panel 103 and UV sensor 104.

The UV sensor 104 monitors the intensity of UV radiation falling on it so that, as long as the UV sensor 104 picks up UV light, the monitoring circuit 102 knows how much radiation a user is exposed to. If the circuit 102 detects that the UV sensor 104 is no longer exposed to the sun, it uses a stored UV index to calculate the dose of UV radiation to which the user has been exposed, on the assumption that the UV index to which the user is exposed is the same as that stored.

An indicator 110 in a form of light or audio sounder or vibrating unit 604 is provided on the unit 100, which is connected to the monitoring circuit 102. The indicator 110 provides an indication that the user wearing a sun screen material has received a predetermined dose of UV radiation. When the “Press” portion 108 is pressed, the monitoring circuit 102 is activated by taking into account a user is going for a swim. The monitoring circuit 102 could assume a certain amount of protection degradation from swimming, or if the portion 108 is pressed again on return, the time spent in the water is calculated and taken that into account so the alarm goes off sooner. The electronic monitoring circuit 102 is powered by the solar panel 103.

FIG. 2 shows the spray head unit 200 of FIG. 1 where the electronic monitoring circuit 201 and all the corresponding components inside the unit 200 are visible. The nozzle 203 has the same function as described for the nozzle 101 in FIG. 1. A lever 204 is shown which is an integral part of the trigger 205 and is accommodated inside the unit 200. The electronic monitoring circuit 201 is provided with a switch 206. When the user triggers the lever 204, the switch 206 is pushed by the lever 204 to activate the circuit 201 and consequently the lotion can be pumped out. FIG. 2 also illustrates a rechargeable battery 207, provided with the electronic monitoring circuit 201. The rechargeable battery 207 is normally powered by the solar panel 208. Thus the circuit 201 can continue to perform the calculations with the power provided by the rechargeable battery 207 even if not exposed to the sun.

FIG. 3 shows the spray head unit 300 as shown in FIGS. 1 and 2 with a skin type dial 301, which enables the user to select the preferred skin type, e.g. sensitive skin and/or less sensitive skin. So when turned to the appropriate setting, the electronic monitoring circuit takes this into account that the user has a certain skin type and adjusts the time so the alarm goes of sooner or later depending on the setting.

FIG. 4 shows the spray head unit 400 in a different configuration shown in any preceding figure. The spray head unit 400 is cylindrical in shape. A nozzle 402 is provided from which the lotion leaves the dispensing container. The electronic monitoring circuit 403 is inside the packaging, whereas the UV sensor 404 is placed on the unit 400. The trigger head 405 is also cylindrical in shape and when pressed, activates the circuit 403, and pumps the lotion out.

FIG. 5 shows a lid 501, 502, 503. The monitoring circuit 504, 505, 506 is attached to or integrated within the lid 501, 502, 503. The location of the monitoring circuit 504, 505, 506 inside the lid 501, 502, 503 could be different as illustrated in FIGS. 5A, 5B, and 5C below:
In FIG. 5A, the monitoring circuit 504 is shown inside the lid 500.
In FIG. 5B, the monitoring circuit 505 is shown inside the lid 502 or more hidden from that shown in FIG. 5A.
In FIG. 5C, the monitoring circuit 506 is shown inside/hidden from view.

It will be appreciated by the person of skill in the art that various modifications may be made to the above described embodiments without departing from the scope of the present invention. For example, whilst the above figures are the examples relating to the effectiveness reduction of the sun screen material, they are equally applicable to the expiration of the medicinal products, amongst others, food and beverage products, cosmetics and toiletries, cleaning products etc.

FIG. 6 shows a cap 601 for an ointment tube with the monitoring circuit 602 inside. This cap 601 can be equally used for a sun screen material tube. The monitoring circuit 602 is provided with various sensors, power source and switch 603. There is an indicator light or an audio sounder or vibrating unit 604 attached to or integrated within the monitoring circuit 602. Whenever the tube is removed from the cap, the switch 603 activates the monitoring circuit 602 and sensors. When the ointment has expired or the effectiveness of the sunscreen material is reduced below a predetermined level, the indicator light 604 flashes or the audio sounder 604 gets activated or the vibration unit 604 starts vibrating to warn the user.

FIG. 7 illustrates a tube cap 700 used for the ointment tube or sun screen material tube. The cap 700 comprises the monitoring circuit 701 and the monitoring circuit switch 702. A seal 703 is provided between the monitoring circuit switch 702 and the ointment tube or sunscreen material tube. Whenever the tube is removed from the cap 700, the seal 703 presses the switch 702 to turn on the monitoring circuit 701.

1. A product monitoring device indicating that the effectiveness of a product has been reduced below a predetermined level, the device being attached to or integrated within a packaging for the product.

2. The device as claimed in claim 1, wherein the device is a UV radiation monitoring device.

3. The device as claimed in claim 1, wherein the product is a sun protection material in the form of a liquid, cream or lotion.

4. A product monitoring device that provides an indication that a user has received a predetermined dose of UV radiation, the device forming part of a packaging for a sun protection material.

5. The device as claimed in claim 3, wherein the device is attached to or integrated within a body, lid, cap or spray unit of a container for the product.

6. The device as claimed in claim 5, wherein the container is in the form of a dispenser.

7. The device as claimed in claim 6, wherein the device is activated when a portion of the dispenser is pressed to dispense the sun protection material.

8. The device as claimed in claim 6, wherein the device is activated when the lid of the container is removed.

9. The device as claimed in claim 6, wherein the device is activated when the lid of the container is flipped open.

10. The device as claimed in claim 3, wherein the device is provided with pre-programmed data for the sun protection material comprising:
SPF rating; and
target skin type.

11. The device as claimed in claim 3, wherein (a) the device stores a UV index that the device is exposed to; and (b) if the device detects that it has been removed from exposure to the sun, it uses the stored UV index to calculate the dose of UV radiation to which the user has been exposed, on the assumption that the UV index to which the user is exposed is the same as that stored.

12. The device as claimed in claim 3, wherein the device is provided with a user operated control to indicate that the user intends to enter water, and in response to operation of the control revises the calculation of when the user has received the predetermined dose, to take into account the degradation of the sun protection material.

13. The device as claimed in claim 3, wherein the device is arranged to provide a warning when the effectiveness of the sun protection material applied by the user has reduced below a predetermined level.

14. The device as claimed in claim 3, wherein the device is associated with a container of sun screen material and is arranged to provide a warning when the sun screen material in the container has reached the end of its useful life.

15. The device of claim 1, wherein the indication that the effectiveness of a product has been reduced below a predetermined level is an indication that the product has expired.

16. The device as claimed in claim 15, wherein the device is provided with a clock function for measuring and maintaining the time.

17. The device as claimed in claim 15, wherein the device is provided with one or more sensors for monitoring the condition and/or environment of the product and/or its packaging.

18. The device as claimed in claim 17, wherein the one or more sensors monitors one or more of:
UV radiation;
Temperature;
Air;
Humidity;
moisture, and
agitation.

19. The device as claimed in claim 18, wherein the device is provided with preprogrammed product data comprising one or more of:
the date of manufacture;
the latest possible expiration date;
thermal tolerance;
air tolerance;
oxidation tolerance;
moisture tolerance;
agitation tolerance, and
UV radiation tolerance.

20. The device as claimed in claim 17, wherein the sensors are activated by a manual switch.

21. The device as claimed in claim 17, wherein the sensors are activated automatically.

22. The device as claimed in claim 21, wherein the device (a) stores sensor data gathered by the one or more sensors; (b) analyses the sensor data in conjunction with the pre-programmed product data; and (c) determines the time until expiry of product given the exposure of the product to various conditions.

23. The device as claimed in claim 22, wherein the device is provided with an indicator for indicating that the product has expired.

24. The device as claimed in claim 23, wherein the indicator is provided by one or more of:
a visual indicator;
an audio indicator;
a haptic indicator, and
a vibrating indicator.

25. The device as claimed in claim 15, wherein the device is provided with a display for displaying the time until the product is due to expire.

26. The device as claimed in claim 1, wherein the device is powered by a battery.

27. The device as claimed in claim 26, wherein the battery is a rechargeable battery powered by a solar cell.

28. A package comprising (a) a container for a product and (b) a monitoring device that provides an indication that the effectiveness of the product has been reduced below a predetermined level.

29. The package as claimed in claim 28, wherein the device is attached to or integrated within the container.

30. The package as claimed in claim 28.
